(19) United States
(12) Patent Application Publication
(10) Pub. No.: US 2012/0067354 A1
(43) Pub. Date: Mar. 22, 2012

(54) SKEWED-AXIS THREE DEGREE-OF-FREEDOM REMOTE-CENTER GIMBAL

(75) Inventor: Pieter Lammertse, Amstelveen (NL)

(73) Assignee: MOOG B.V., Nieuw-Vennep (NL)

(21) Appl. No.: 13/375,411

(22) PCT Filed: Jun. 3, 2009
(86) PCT No.: PCT/IB2009/005852

§ 371 Date: Nov. 30, 2011

(51) Int. Cl. A61G 15/00

(52) U.S. Cl. 128/845

(57) ABSTRACT

A remote-center three degree-of-freedom gimbal (20) includes: a support (21); a first link (24) mounted on the support for pivotal movement about a first axis (z-z); a second link (25) mounted on the first link for pivotal movement about a second axis (x-x); and a member (26) mounted on the second link for pivotal movement about a third axis (y-y); wherein said axes intersect at an imaginary point (28); and wherein said first and second links are configured as arcuate segments.

### TECHNICAL FIELD

The present invention relates generally to gimbals and gimbal-like mechanisms that may be used in assisting a patient in using his injured limb to accomplish certain activities of daily life (“ADL”) during rehabilitation.

### BACKGROUND ART

During rehabilitation, it is sometimes desired to support a patient's arm in such a way as to enable the patient to engage in certain activities of daily life, such as drawing or writing, reaching for objects on shelves, handling cups for drinking, eating and the like, combing hair, opening doors, etc. It is known to use conventional ring gimbals in connection with a haptic device for this purpose. However, such ring gimbals have a relatively large mass, and sometimes interfere with some of the patient's desired activities. For example, the ring gimbal may prevent the patient from laying his hand directly on a table, or reaching for a small object laying on the table.

There are thousands of gimbal designs but almost all of these are aimed at homokinetic motion, or a large range of motion in certain directions. See, e.g., U.S. Pat. No. 6,105,455. However, the gimbals in this patent do not have an open center of rotation.

There are also numerous “remote center” mechanisms. These are usually flat mechanisms that are intended to provide rotation about a single axis. See, e.g., U.S. Pat. No. 7,021,173 B2. However, these gimbals do not allow rotation about two or three axes focused on an open center. There are a few three-axis mechanisms that do have a remote center; i.e., an arrangement in which there are no moving parts present at the center of rotation. See, e.g., U.S. Pat. No. 5,816,105.

There is believed to be a need for a reduced-mass low-profile open-center gimbal mechanism that could be utilized in a patient's rehabilitation, and that would allow a wide range of motion of a patient's limb (e.g., arm or leg), such as when engaging in the activities of daily life. Such an arrangement would also mandate that there be no structure at the remote center of movement.

### DISCLOSURE OF THE INVENTION

With parenthetical reference to the corresponding parts portions or surfaces of the disclosed embodiment, merely for purposes of illustration and not by way of limitation, the present invention broadly provides an improved skewed-axis three degree-of-freedom remote-center gimbal (20).

The improved gimbal broadly includes: a support (21); a first link (24) mounted on the support for pivotal movement about a first axis (z-z); a second link (25) mounted on the first link for pivotal movement about a second axis (x-x); and a member (26) mounted on the second link for pivotal movement about a third axis (y-y); wherein the axes intersect at an imaginary point (28); and wherein the first and second links are configured as arcuate segments.

The pivotal axes may be orthogonal.

The first link (24) may include a portion occupying an arc of 90°. The first link portion may be in the shape of a quarter circle.

The second link (25) may include a portion occupying an arc of 90°. The second link portion may be in the shape of a quarter circle.

The member may have an axis of elongation arranged at an angle with respect to the third axis. This angle may be about 45°.

The member (26) may provide a support for a patient's limb (i.e., an arm or a leg). The improved gimbal may allow enhanced movement of the limb in the activities of daily life of the patient.

The second link may include a first element (29) mounted on the first link for pivotal movement about the second axis, and may include a second element (30) mounted on the first element for pivotal movement about a fourth axis (r-r), and wherein the member is mounted on the second element for pivotal movement about the third axis.

The fourth axis (r-r) may be arranged to intersect the other axes at the imaginary point.

The gimbal may be passive (i.e., unpowered) or active (i.e., powered), and the position of at least one of the links may be controlled by a closed position servoloop.

Accordingly, the object of the invention is to provide a skewed-axis three degree-of-freedom remote-center gimbal.

Another object is to provide an improved low-mass gimbal that is useful in assisting a patient, particularly one in rehabilitation, to perform certain activities of daily life.

These and other objects and advantages will become apparent from the foregoing and ongoing written specification, the drawings and the appended claims.

### BRIEF DESCRIPTION OF THE DRAWINGS

FIG. 1 is an isometric view showing a first form of the improved gimbal as being mounted on the extendable end of a haptic actuator.

FIG. 2 is a top plan view of the structure shown in FIG. 1.

FIG. 3 is a front elevation of the structure shown in FIG. 1.

FIG. 4 is a right end elevation of the structure shown in FIG. 1.

FIG. 5 is an isometric view of a portion of a second form of the improved gimbal, this view showing the second link as being formed of two elements.

FIG. 6 is an isometric view, generally similar to FIG. 1, and schematically showing how the apparatus might be implemented for active control.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Referring now to the drawings, the present invention broadly provides an improved remote-center three degree-of-freedom gimbal, generally indicated at 20, which is particularly adapted for use in (but is not limited to) supporting a patient's limb (e.g., his arm) during rehabilitation so as to enable the patient to more easily simulate various activities of daily life. These activities may, for example, include various writing and drafting skills, drinking, eating or combing hair, reaching, opening doors, and the like.

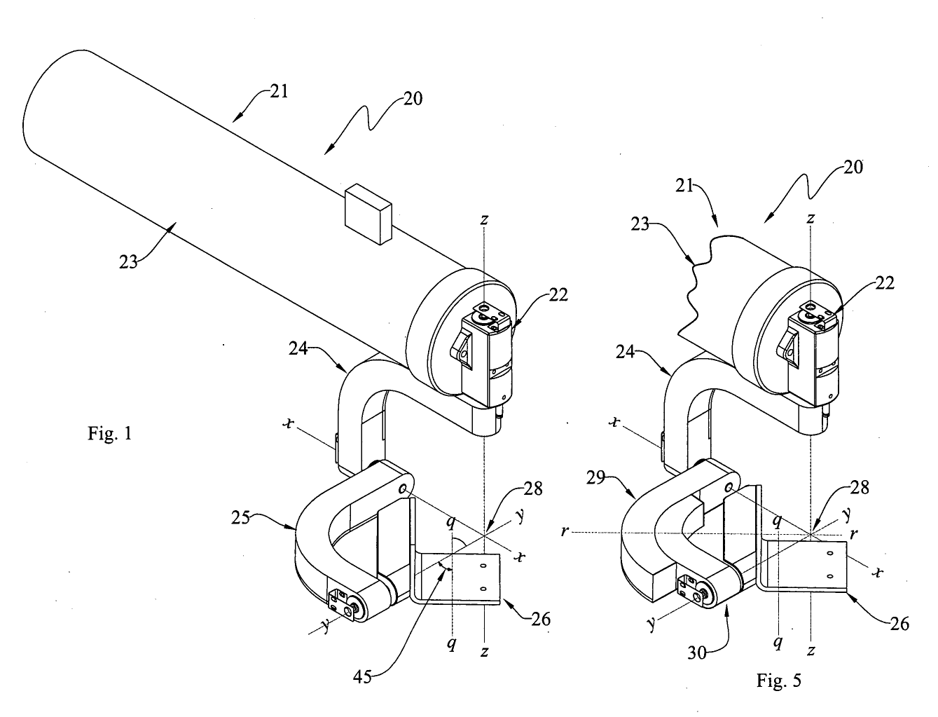

In the accompanying drawings, the improved gimbal is shown as broadly including a support, generally indicated at 21, having an extensible rod 22 telescopically received in a cylinder 23. In the drawings, the rod 22 is shown as having been retracted into cylinder 23. A first link 24 is mounted on the support for pivotal movement about a vertical first axis z-z. In FIGS. 1-4, a second link 25 is mounted on the first link for pivotal movement about a horizontal second axis x-x. A member 26 mounted on the second link for pivotal movement about a horizontal third axis y-y. The first and second links are configured as arcuate segments. In the accompanying drawings, the three axes x-x, y-y, and z-z are orthogonal, and converge at an imaginary point, indicated at 28. The first link 24 includes a portion occupying an arc of about 90°. This arc may be smooth and curved (as shown), or, alternatively, may be in the form of a series of incremental segments (not shown). The illustrated form, the first link portion occupies an arc of 90°, and is in the shape of a quarter circle.

Similarly, the second link includes a portion occupying an arc of about 90°. Here again, this second link portion may be smooth, continuous and curved (as shown), or, alternatively, may be in the form of a series of incremental segments (not shown). In the illustrated form, the second link portion is also in the shape of a quarter circle.

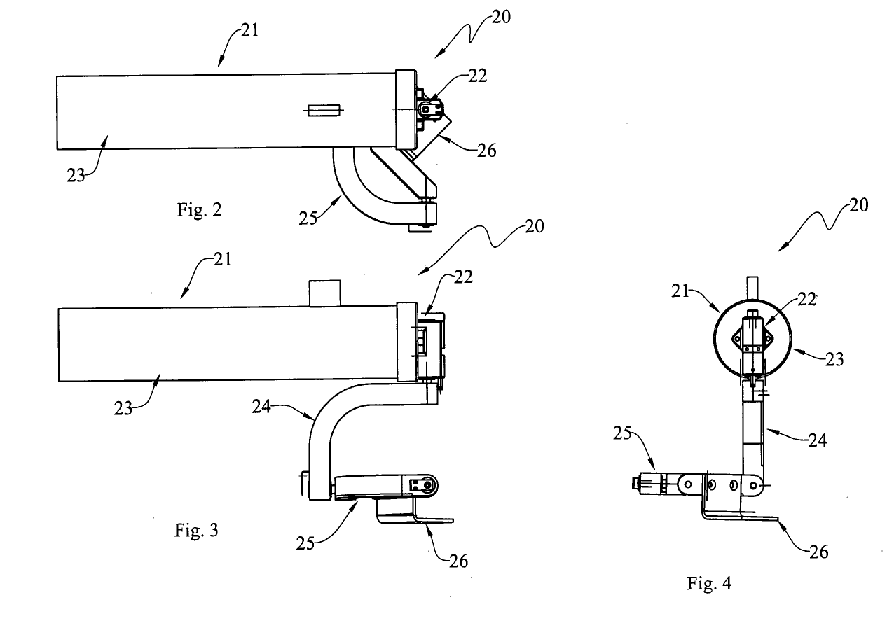

As best shown in FIGS. 1 and 2, the member has an axis of elongation (q-q) arranged at a skewed angle with respect to the third axis (y-y). The angle is specifically shown as being about 45° in FIG. 1.

In actual practice, a suitable concave cradle (not shown) would be placed on and secured to member 26 so as to provide a trough-like receptacle to receive the patient's limb. Thus, the member is adapted to support a patient's limb (e.g., an arm or a leg), and the gimbal allows a wide range of movement of the limb so as to simulate the activities of daily life of the patient. At the same time, the improved gimbal has substantially reduced mass, and does not overly interfere with such activities of daily life.

As shown in FIG. 5, in an alternative form, the second link may include a first element 29 mounted on the first link for pivotal movement about the second axis (x-x), and may include a second element 30 mounted on the first element for pivotal movement about a fourth axis (r-r), and wherein the member is mounted on the second links second element for pivotal movement about the third axis. The fourth axis may be arranged to intersect the other axes at the imaginary point 28.

The improved gimbal may be unpowered in the sense that it passively reacts to and enables movement of the patient's limb in the appropriate direction as the patient attempts to accomplish various activities in his daily life. On the other hand, the various axes could, in some alternative form, be powered, as desired.

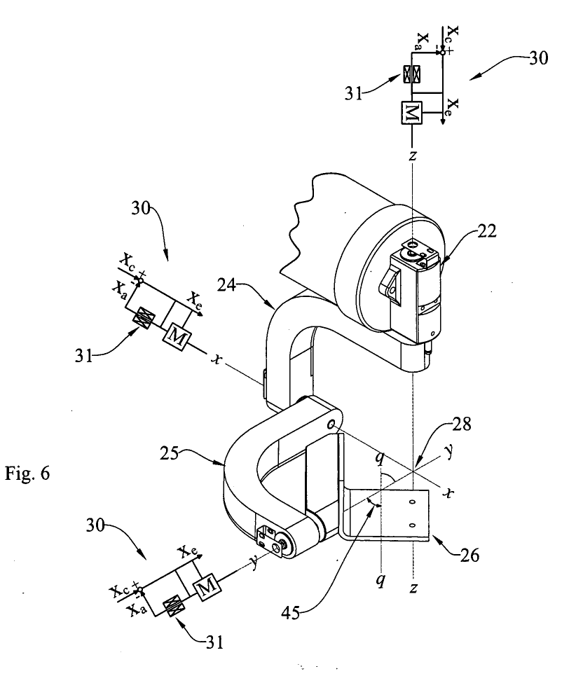

FIG. 6 is an isometric view, generally similar to FIG. 1, schematically showing how the apparatus might possibly be implemented for active (as opposed to passive) control. In FIG. 6, a closed loop position control circuit, generally indicated at 30, is associated with each of the axes, x-x, y-y and z-z. Each control loop is shown as being supplied with a position command signal x_{c}. This signal is then supplied to a summing point, which adds the command signal with a negative position feedback signal xₐ, as determined by position sensors 31. The difference therebetween is supplied as a position error signal xₑ. The motor M then adjusts the position of the movable member along the associated axis as a function of the position error signal so as to drive the position error toward zero. Thus, this arrangement can be used to provide a powered gimbal.

Therefore, while the presently-preferred form of the improved gimbal has been shown and described, and several modifications thereof discussed, persons skilled in this art will readily appreciate that various additional changes may be made without departing from the spirit of the invention, as defined and differentiated by the following claims.

What is claimed is:

1. A remote-center three degree-of-freedom gimbal, comprising:
a support;
a first link mounted on said support for pivotal movement about a first axis;
a second link mounted on said first link for pivotal movement about a second axis; and
a member mounted on said second link for pivotal movement about a third axis;
wherein said axes intersect at an imaginary point; and
wherein said first and second links are configured as arcuate segments.

2. A remote-center three degree-of-freedom gimbal as set forth in claim 1 wherein said pivotal axes are orthogonal.

3. A remote-center three degree-of-freedom gimbal as set forth in claim 1 wherein said first link includes a portion occupying an arc of 90°.

4. A remote-center three degree-of-freedom gimbal as set forth in claim 3 wherein said first link portion is in the shape of a quarter circle.

5. A remote-center three degree-of-freedom gimbal as set forth in claim 1 wherein said second link includes a portion occupying an arc of 90°.

6. A remote-center three degree-of-freedom gimbal as set forth in claim 5 wherein said second link portion is in the shape of a quarter circle.

7. A remote-center three degree-of-freedom gimbal as set forth in claim 1 wherein said member has an axis of elongation arranged at an angle with respect to said third axis.

8. A remote-center three degree-of-freedom gimbal as set forth in claim 7 wherein said angle is about 45°.

9. A remote-center three degree-of-freedom gimbal as set forth in claim 1 wherein said member is a support for a patient's limb.

10. A remote-center three degree-of-freedom gimbal as set forth in claim 9 wherein said gimbal will allow movement of said limb in the activities of daily life of said patient.

11. A remote-center three degree-of-freedom gimbal as set forth in claim 1 wherein said second link includes a first element mounted on said first link for pivotal movement about said second axis, and includes a second element mounted on said first element for pivotal movement about a fourth axis, and wherein said member is mounted on said second element for pivotal movement about said third axis.

12. A remote-center three degree-of-freedom gimbal as set forth in claim 11 wherein said fourth axis is arrange to intersect the other axes at said imaginary point.

13. A remote-center three degree-of-freedom gimbal as set forth in claim 1 wherein said gimbal is passive.

14. A remote-center three degree-of-freedom gimbal as set forth in claim 1 wherein said gimbal is powered.

15. A remote-center three degree-of-freedom gimbal as set forth in claim 15 wherein the position of at least one of said links is controlled by a closed position servoloop.
